(19) United States
(12) Patent Application Publication
(10) Pub. No.: US 2025/0299842 A1
(43) Pub. Date: Sep. 25, 2025

(54) SYSTEM AND METHOD FOR LUNAR AND PLANETARY NUCLEAR REACTOR

(71) Applicant: Canadian Space Mining Corporation, Toronto (CA)

(72) Inventor: Richard BOUDREAULT, Montreal (CA)

(21) Appl. No.: 18/869,614

(22) PCT Filed: May 26, 2023
(86) PCT No.: PCT/CA2023/050730

§ 371 Date: Nov. 26, 2024

Related U.S. Application Data
(60) Provisional application No. 63/345,926, filed on May 26, 2022.

(51) Int. Cl. G21C 1/30; B64G 99/00; G21D 1/00; G21D 5/08; G21D 7/04; G21D 9/00

(52) U.S. Cl. CPC G21C 1/30; B64G 99/00; G21D 1/00; G21D 5/08; G21D 7/04; G21D 9/00

(57) ABSTRACT

A controlled reactor comprises a reactor core thermally coupled to one or more heat pipes and an active cooling loop. A fluid may be circulated through the active cooling loop. A heat exchanger is thermally coupled to the active cooling loop and extracts heat from the fluid as the fluid is circulated through the active cooling loop. A heating system may be provided to deliver the heat extracted by the heat exchanger to a community. A thermoelectric generator may be provided to convert heat extracted by the heat pipes to electricity for delivery to the community.

### RELATED APPLICATIONS

This application claims priority from U.S. Provisional Patent Application Ser. No. 63/345,926 filed on May 26, 2022 entitled “SYSTEM AND METHOD FOR LUNAR AND PLANETARY NUCLEAR REACTOR”, which is incorporated herein by reference in its entirety. For the purposes of the United States, this application claims the benefit under 35 USC § 119 of U.S. Provisional Application Ser. No. 63/345,926 filed on May 26, 2022 entitled “SYSTEM AND METHOD FOR LUNAR AND PLANETARY NUCLEAR REACTOR”, which is incorporated herein by reference in its entirety.

### TECHNICAL FIELD

The present disclosure relates generally to the generation, storage, and transmission of heat and power, and more specifically to a nuclear reactor and system for the generation, storage, and transmission of heat and power. Some embodiments have example applications for use in space, the lunar or planetary environment, or extreme environments such as the arctic.

### BACKGROUND

Space exploration is important for scientific discovery and technological innovation, as it can inspire people to learn more about the universe and develop new technologies. Advanced space exploration in the future (e.g., deep-space missions) will require a sustained presence on the Moon or another extraterrestrial body in the solar system. To sustain such a presence, a tremendous amount of continuous energy and power will need to be supplied on or to the extraterrestrial body.

In situ resource utilization (ISRU) is the practice of collecting, processing, storing and using materials found or manufactured on other astronomical objects (e.g., the Moon, Mars, asteroids, etc.) to replace materials that would otherwise need to be transported from Earth. ISRU is key for establishing a sustained lunar presence and will likely involve mining operations on the Moon. ISRU can also potentially involve supplying Earth with critical material and/or nuclear fusion target material.

Mining and the processing of minerals into consumable products can be energy intensive and is generally practiced eccentrically at the location of power generation systems. On Earth, extraction uses mostly hydrocarbon-based fuel, while refineries and processes are mostly powered by gas or electricity. Ore processes are mostly based on endothermic processes as is also the case in extraterrestrial environments. Ore processing requires high quality heat and fairly large amounts electricity (e.g., hundreds of kW to sub-MW levels according to the International Space Exploration Coordination Group (ISECG) in 2021). On Earth, for typical mining operations, the energy cost represents about one third of all expenses. Similar energy cost arises from refining and metallurgy. For ore processing, temperatures of around 1,300-1,400° C. are usually expected.

At the present time, power in space and extraterrestrial environments is mostly supplied by low voltage power produced from photovoltaic (PV) and Radio-isotopic Thermal Generator (RTG) units. A RTG unit is a type of nuclear battery that uses an array of thermocouples to convert the heat released by the decay of a suitable radioactive material into electricity by the Seebeck Peltier effect. Unfortunately, an RTG unit having a weight of about 38 kg including about 4.5 kg of Pu-238 can only provide enough heat to generate approximately 150 watts of electrical power and about 2 KW of thermal power. Such units also require supplementary means for storing vast amounts of energy during the lunar night. In addition, there is high payload weight associated with deploying the solar panels on the Moon as well as providing the large amounts of batteries required for storing of the electrical power. As such, RTG units are not capable of supplying enough power to support the intensive mining operations required for ISRU.

Nuclear reactors are a promising source of power because they provide continuous energy, unlike photovoltaic solutions whose power production depends on illumination conditions, which in the case of the Moon is unfavourable at most locations (i.e., at locations except the pole regions) because the lunar night spans about fourteen (14) days. Nuclear reactors can be a reliable source of both high-quality and low-quality temperature loops, electrical power, and isotopes. Accordingly, nuclear reactors should in theory be capable of supplying enough power to support the mining operations required to support ISRU on the Moon or other planetary bodies.

Unfortunately, current nuclear reactor designs are not suitable for use on the Moon or other planetary surfaces. One issue is that they are typically too large to be landed on the Moon or buried into the regolith. Another issue is that they are designed to operate in the surface gravity of Earth, and not suitable for operation on the Moon, which has a surface gravity that is about ⅙^{th} as powerful as that of the Earth.

There remains a need for small modular reactors (SMRs) that can overcome the abovementioned deficiencies. There remains a need for nuclear reactors, such as SMRs, that can be operated effectively on extraterrestrial bodies like the Moon. Such reactors should be designed or otherwise configured to provide a relatively high payback ratio (PBR) energy to support the human exploration and settling of the solar system.

The background provided in this disclosure is intended to introduce the reader to the detailed description that follows and not intended to define or limit the subject matter.

Power is a critical component of spaceflight. Radioisotope Thermoelectric Generators (RTGs) have provided power on at least 27 space missions including the Apollo, Viking, Curiosity, Voyager, and Cassini missions (per NASA in 2013). The most common fuel for RTGs is 238Pu, which can cause significant accidents risks during launch. Furthermore, RTGs are not easily scalable to the degree that is needed for upcoming missions, which solidifies the need for nuclear reactors. Nuclear reactors have heritage in the US Navy, where all submarines and supercarriers built since 1975 rely on nuclear reactors for power. The nuclear reactors allowed these vessels to operate for up to 20 years without the need to refuel (per the United States Environmental Protection Agency in 2021). Another noteworthy project is the 1965 Nuclear Engine for Rocket Vehicle Applications (NERVA) where NASA and the Atomic Energy Commission designed and tested a nuclear-powered rocket for potential deep space applications. Past interest in nuclear reactors for space missions is now resurfacing in the new race to the Moon.

It has been reported that ROSCOSMOS's upcoming Luna-Glob missions, Luna 25-28, aim to collect Moon samples to study regolith and water ice at the lunar south pole, deploy a polar orbiter to study the lunar surface and environment, and land around 15 scientific instruments to collect further data regarding regolith, plasma, and dust. ROSCOSMOS is also preparing for their mission in 2030, Zeus, which will use a nuclear-powered transport and energy module from the Moon to Venus and Jupiter.

Already the Chinese Chang'e 5 mission has confirmed the Apollo results, with the presence of 120-200 ppm of water in Mare in the very top layer of Regolith. But also, of Rare-Earth (REE) Materials of critical importance to the terrestrial green energy and defense sectors. It has been reported that CNSA's upcoming Chang'e missions, Chang'e 6-8, aim to collect moon samples to provide information regarding the history and origin of the Moon and solar system, study the lunar environment and sources of water and volatiles through surface and orbital prospecting, and begin establishing the International Lunar Research Station (ILRS) to test in-situ resource technologies and promote human long-term stay on the lunar surface. CNSA realizes the tremendous amount of continuous power needed to support a sustained lunar presence and has developed a nuclear reactor that can generate a megawatt of electricity. China hopes this nuclear reactor will enable their long-term exploration of Mars as well.

Canada's Canada Deuterium Uranium (CANDU) reactor uses natural uranium or thorium as fuel and deuterium enriched water (heavy water) for cooling. CANDU reactors provide power in seven countries worldwide. The first CANDU reactors were developed in the late 1950s with frequent design updates occurring up to present date (CANDU Reactor, 2022). The CANDU reactor is a potential source of Helium-3 resulting from the decay of tritium found in the heavy water. Thus, CANDU has the potential to both provide fuel for future nuclear fusion power plants as well as provide power on the lunar surface. Other iconic Canadian technologies include the Safe Low-Power Kritical Experiment (SLOWPOKE) reactors which are primarily intended to provide a neutron source. The SLOWPOKE-3 is a nuclear heating reactor that is designed to provide up to 20 MW (thermal) of hot water and potentially electricity. A by-product of its high safety levels is that it can operate remotely.

The SLOWPOKE-2 is a controlled reactor that has been operating for more than forty years, it is certified, and was recertified once, and has been operated by universities throughout Canada at downtown campuses including Montreal's Polytechnique and the Royal Military College in Kingston. It is inherently stable and capable of being operated at distance with minimal human involvement. Canada has conceived and developed multiple versions of its Slowpoke. The current Slowpoke reactor core occupies a cylindrical volume of about 22 cm in diameter and 22 cm high, housed about 5 m below ground level in the passive cooling reactor pool. The pool and the reactor are housed in an ordinary classroom-size room with a taller than usual ceiling, according to RMC. It could generate up to 20 KW of power, but is used solely to produce neutrons.

U.S. Pat. No. 11,302,452 entitled “Nuclear reactor cooling arrangement having a Stirling engine” discloses a reactor cooling and power generation system according to the present disclosure includes a reactor vessel, a heat exchange section formed to receive heat generated from a core inside the reactor vessel, from a feedwater system through a fluid, and an electric power production section. A Stirling engine is provided to produce electric energy using the energy of the fluid whose temperature has increased while receiving the heat of the reactor. The system is formed to circulate the fluid that has received heat from the core in the heat exchange section through the electric power production section. The system operates even during a normal operation and during an accident of the nuclear power plant. The reactor cooling and power generation system accompanies a nuclear reactor vessel which includes a reactor coolant system, a feedwater system and a steam generator. A turbine can also be used to produce electric power from the feed water system. Peltier stages can transform heat into electrical power.

The Stirling engine was developed by Robert Stirling in 1816 as an external combustion engine, which tightly holds gas in a closed cylinder and drives an actuator in the for of a type of piston, which moves according to the strokes of heating, expansion, cooling and compression to produce work and furthermore can produce electrical power.

High payback ratio (PBR) energy is important for the exploration and settling of the solar system. Solar concentration can provide low-cost power, however, intermittently in nature. Nuclear remains as a source of both high- and low-quality temperature loops, electrical power, and an isotope source.

Following Artemis III in 2025, activities that support the construction of the Artemis Base Camp will commence. It has been reported that communications systems, charging stations, long distance rovers, electrostatic radiation shielding, ISRU processing, and other activities may each require 0.1≤30 KW for operation. Upon completion of the base camp around year 2035 (e.g., by the International Space Exploration Coordination Group), up to 100 KW of continuous power could be required depending on the camp size and number of residents.

However, the Small Modular Reactors (SMR) certification for a new nuclear device is to be counted in decades, and the trust of an untested devices would be low and need to accommodate significant security systems that are just not necessary on a Slowpoke which has a perfect safety record and ease of operations.

In 2018, using a uranium-235 reactor core with high-efficiency Stirling engines, NASA successfully demonstrated the Kilopower Reactor Using Stirling Technology (KRUSTY) that can provide up to 10 kW of continuous power for up to 10 years. Furthermore, in November 2021, NASA and Battelle Energy Alliance released a Request for Proposal regarding fission power on the lunar surface with a goal of demonstration before the end of the decade. The proposed reactor must provide at least 40 kWe continuous power for a minimum of 10 years, limit radiation exposure to 5 rem/year from 1 km away, and have a mass less than 6000 kg, among other requirements.

The paper entitled “LEU-FUELLED SLOWPOKE-2 RESEARCH REACTORS: OPERATIONAL EXPERIENCE AND UTILISATION” by G. Kennedy and J. St. Pierre Nuclear Engineering Institute, Ecole Polytechnique Montreal, Quebec, Canada and L.G.I. Bennett and K.S. Nielsen SLOWPOKE-2 Facility at Royal Military College Kingston, Ontario, Canada describes a known SLOWPOKE nuclear reactor as is generally shown in FIG. 1A and sections of the paper are herein incorporated. FIG. 1B illustrates a core of the SLOWPOKE-2 reactor as is known to those of skill in the art.

Atomic Energy of Canada Limited designed the SLOWPOKE-2 research reactor based on experience with the SLOWPOKE-1 prototype, which operated for four years at the University of Toronto. Between 1976 and 1984, seven SLOWPOKE-2 reactors with HEU fuel were commissioned in six Canadian cities and in Kingston, Jamaica. They use 93% enriched uranium in the form of 28% uranium-aluminum alloy with aluminum cladding. The core is an assembly of about 300 fuel pins, only 22 cm diameter and 23 cm high, surrounded by a fixed beryllium annulus and a bottom beryllium slab. Criticality is maintained by adding beryllium plates in a tray on top of the core. A schematic drawing of the core with irradiation sites is shown in FIG. 1A.

Maximum thermal power is presently 20 KW and heat is removed by natural convection of the light water moderator. The maximum neutron flux in an inner irradiation site is 1×10¹² cm⁻²s⁻¹. Excess reactivity is limited to 4 mk. Every two or three years a beryllium shim-plate is added to compensate the loss of reactivity due to U-235 burnup and the production of long-lived poisons.

The SLOWPOKE-2 reactor is inherently safe due to its very limited excess reactivity and large negative temperature coefficient of reactivity. As a result, an attendant operator is not required, and the reactor is licensed for remotely attended operation up to 24 hours. In practice, all licensed operators are primarily researchers as analytical chemists, physicists, professors, etc.

In 1985, the first LEU-fueled SLOWPOKE-2 reactor was commissioned at the Royal Military College of Canada (RMC) in Kingston, Ontario. The newer LEU fuel is constructed in the same manner as CANDU fuel, Zircaloy-clad, but with 20% enrichment instead of natural uranium oxide. The pool, reactor water container, light water moderator, beryllium reflector, cadmium control rod and irradiation sites are the same as for the HEU-fueled reactors. The details of the two types of SLOWPOKE-2 reactor cores are given in FIG. 2A.

The reactor at Ecole Polytechnique, Montreal was installed in 1976 and operated with HEU fuel for 21 years. In 1997 the tray of beryllium shim-plates was full and there was no remaining excess reactivity. The exhausted fuel was removed and replaced with LEU fuel in the same beryllium reflector, making it essentially identical to the reactor at RMC.

The lifetime of a SLOWPOKE reactor core depends on the amount of use and on the amount of reactivity that can be added with beryllium shims. A complete 10 cm thick stack of shims is worth about 20 mk. However, when the HEU cores were installed, at least 1 cm of beryllium was placed in the tray to reach criticality, and this beryllium, being closest to the fuel, had the greatest worth. There was less than 15 mk remaining to compensate U-235 burnup and poisons. With an average operating power of 1.3 KW (11 MWh/year, typical for the more heavily used reactors), this reactivity is used up in about 20 years. At two of the reactors, in Toronto and Halifax, this lifetime was extended by adding more beryllium as a second annulus above the annular reflector. With the LEU cores and increased experience, it is now possible to reach near criticality by adding fuel alone, with no beryllium in the shim tray. Thus, there remains a full 20 mk to compensate reactivity losses. This increases the life of the core by more than a factor of 20/15 because the reactivity losses are highest in the first few years until the main poison, Sm-149, reaches its saturation level. The lifetime of the two reactors with LEU fuel is thus expected to be about 40 years prior to refueling.

A very important feature of the SLOWPOKE-2 reactor is its inherent safety due to its limited excess reactivity and large negative temperature coefficient of reactivity. With both the HEU and the LEU cores, power excursions were carried out during commissioning up to the maximum credible reactivity insertion of 4.3 mk. For both types of cores, the power reached about 80 KW after about 2 minutes before levelling off. At lower powers (lower temperatures), the negative feedback with temperature increase is greater with the HEU core and, for reactivity insertions less than 4.3 mk, lower powers are reached with the HEU core. Both cores are highly under moderated but the HEU core even more so because there is less water in the volume of the core (e.g., see Table 1 below). At 80 KW some boiling may take place with both cores, causing rapid negative feedback, and the LEU core has additional negative feedback due to the U-238. Considering all the reactivity feedback effects, the HEU and LEU cores are roughly equivalent from a safety standpoint, since neither can reach temperatures which could cause damage to the fuel after any credible reactivity insertion.

During normal operation the reactor water temperature varies between 200° C. and 600° C. at 20 kW output. With the HEU core, the reactor has maximum reactivity at 190° C. and thus reactivity always decreases as temperature increases from room temperature to operating temperature. During early operation of the LEU-fueled reactor at RMC with low starting temperatures, an increase in reactivity with temperature, as deduced from the control rod movement, was noticed. Subsequent measurements showed that the maximum occurred at 330° C. The original reactor simulations were not sufficiently accurate to predict this difference between the two reactors, but a more recent thermodynamic model has reproduced the observed variations. This reduced reactivity loss with increasing temperature allows the LEU-fueled reactor to operate for a longer time at full power. With a starting temperature of 200° C. and excess reactivity 4.0 mk, the HEU reactor will run for 16 h at 20 KW and the LEU reactor for 24 h. The LEU reactor can run continuously for 5 days at 10 KW. The differences in maximum operating time are even more noticeable for lower starting excess reactivities, which are the normal situation between shim additions. With the HEU core, when the excess reactivity for a cold reactor decreases to about 2.5 mK, a shim plate must be added to maintain a reasonable operating margin. With the LEU core, this is typically done at about 1.5 mk. This longer time between shim additions results in significant savings in operating costs.

Another advantage of the LEU fuel is the virtual absence of fission products in the reactor water. When the HEU-fueled reactors were new, releases from the fuel to the water were low but they increased as the fuel aged. Releases were highest for the noble gases: the Xe-133 concentration in the reactor water reached a maximum of 6 MBq/L at the Montreal reactor in 1996. At the RMC LEU-fueled reactor the Xe-133 concentration in the reactor water is 5 orders of magnitude lower and is attributed to trace uranium contamination on the surface of the fuel cladding. A visual inspection of the Montreal reactor core in 1991 revealed swelling in the aluminum cladding near the ends of some of the fuel pins around the outside of the core. The fuel pins in the higher power central region of the core could not be viewed. Microfissures in these swellings may contribute to the releases. It has also been theorized that the releases are caused by increasingly exposed uranium in the end-cap welds at the ends of the fuel pins. However, in none of the HEU-fueled reactors has the release of fission products increased to the point where it becomes a radiation safety issue.

After the Montreal reactor was converted to LEU fuel, the Xe-133 concentration in the reactor water decreased by three orders of magnitude but still remained two orders of magnitude higher than the level at the other LEU-fueled reactor at RMC. The residual fission products in the water in Montreal are attributed to about 1 mg of U-235, which was released from the original HEU core and plated out on the beryllium reflector and other reactor container surfaces.

With a thermal neutron flux in an inner irradiation site of 1×10¹² cm⁻²s⁻¹ at an operating power of 20 kW, the SLOWPOKE reactor has an excellent flux/power ratio. While no accurate measurements have been performed of the absolute power of a SLOWPOKE-2 reactor, relative measurements carried out in Montreal allow a comparison of the HEU and LEU cores. In 1996, with the HEU core and a neutron flux of 1×10¹² cm⁻²s⁻¹, the temperature difference between the water flowing out of the core and the water entering the core was 220° C.±10° C. In 1998, with the new LEU core and the same neutron flux, the temperature difference was 240° C.±10 C, which implies a higher reactor power. The 9% higher temperature difference produces an approximately 9% higher in gravity driven convection flow rate. The power with the LEU fuel is thus approximately 18% higher than the power with HEU fuel for the same thermal neutron flux in the irradiation sites. However, diffusion calculations have predicted an LEU/HEU power ratio of 1.06. Considering the uncertainties in the temperature measurements and in the diffusion calculations, we now estimate the LEU reactor to have about 10% higher power. This is attributed to the absorption of neutrons by U-238. This absorption by U-238 also results in different thermal/fast ratios in the irradiation sites. In the inner irradiation sites the thermal/fast ratio was measured to be 4.4 with the HEU core and 4.0 units with the LEU core. Fast neutrons are generally considered a nuisance in neutron activation analysis, the main use of the reactor, because they cause interfering reactions. These nuclear interferences are 10% higher with the LEU core.

Each SLOWPOKE-3 unit is a nuclear heating reactor that is designed to provide up to 20 MW (thermal) of hot water and potentially electricity. A by-product of its high safety levels is that it can operate remotely. This capability makes possible the operation of SLOWPOKE on the Moon, Mars, and beyond.

The foregoing examples of the related art and limitations related thereto are intended to be illustrative and not exclusive. Other limitations of the related art will become apparent to those of skill in the art upon a reading of the specification and a study of the drawings.

### SUMMARY OF THE DISCLOSURE

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention relates to a system for providing heating and electricity to a community, such as a remote community or an extraterrestrial community. The system includes a subcritical or controlled nuclear reactor, a heat exchanger, a heating system, and a thermoelectric generator. The reactor comprises a reactor core thermally coupled to one or more heat pipes and an active cooling loop. The active cooling loop is configured to facilitate circulation of a fluid therethrough. The heat exchanger is thermally coupled to the active cooling loop and configured to extract heat from the fluid circulating through the active cooling loop. The heating system delivers the heat extracted by the heat exchanger to the community. The thermoelectric generator converts heat extracted by the one or more heat pipes to electricity for delivery to the community. A thermal fluid pump system may be provided to circulate the fluid through the active cooling loop.

In some embodiments, the thermoelectric generator comprises a Peltier engine, a Stirling engine, a Brayton engine, and/or a thermodynamic engine. In some embodiments, the reactor has a maximum power output in the range of 10 KW to 50 KW. In some embodiments, the active cooling loop is in direct physical contact with the reactor core.

In some embodiments, the system includes a tank which provides a cooling bath for the reactor core. The reactor core may be immersed in the cooling bath during the operation of the system. The active cooling loop may be thermally coupled to the reactor core through the cooling bath provided by the tank. The heat pipes may be in direct physical contact with the reactor core.

Another aspect of the invention relates to a thermal energy generating system. The system includes a nuclear reactor core, fluid transport systems, and a thermal electric generator system. The nuclear reactor core may be housed in a pressure vessel and disposed within a containment and shield. The nuclear reactor core may be surrounded by a first heat exchanger and a second heat exchanger. The first liquid transport system circulates a first liquid medium through the first heat exchanger to within a first temperature range. The first liquid medium may comprise molted salts. The second liquid transport system circulates a second liquid medium through the second heat exchanger to within a second temperature range that is usually lower than the first temperature. The second liquid medium may comprise water. The thermal electrical generator system is thermally coupled with the second liquid transport system.

In some embodiments, the first heat exchanger is coaxial with the nuclear reactor core. The first heat exchanger may be in direct contact with the nuclear reactor core. In some embodiments, the second heat exchanger is coaxial with the first heat exchanger. The second heat exchanger may be radially spaced from the nuclear reactor core. In some embodiments, a reactivity control system may be operated to controllably position control rods within the nuclear reactor core. The control rods can control the reactivity and thermal output of the system. In some embodiments, the system comprises a hatch for providing access to the nuclear reactor core, the first liquid transport system, and the second fluid transport system.

In some embodiments, the thermal electrical generator system comprises a hot heat pipe, a cold heat pipe, and at least one of a Stirling generator, a Peltier generator, and a Seebeck generator located between the hot heat pipe and the cold heat pipe. Temperature difference between the hot heat pipe and the cold heat pipe is usually about 100° C. during operation of the system.

Other aspects of the invention relate to methods for providing a thermal energy generating system on a planetary body. In one embodiment, the method comprises the steps of assembling a thermal energy generating system within a fairing of a launch vehicle as part of a stage, launching the launch vehicle beyond Earth's orbit, deploying the stage in space at a location where the stage is gravitationally attracted to the planetary body, and landing the thermal energy generating system on the planetary body. The thermal energy generating system may be at least partially buried within regolith. A reactor of the thermal energy generating system may be filled with water generated from a fuel cell interaction of pressurized hydrogen and oxygen.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive. Features and advantages of the embodiments of the present invention will become apparent from the following detailed description, taken with reference to the appended drawings in which:

FIG. 1A illustrates a section of a SLOWPOKE nuclear reactor and core. FIG. 1B is a perspective view of a section of a SLOWPOKE nuclear reactor and core.

FIG. 2A is a block diagram of an integrated system that may be used to provide power to a community. FIG. 2B is a schematic illustration of an example embodiment of a nuclear reactor of the FIG. 2A system. FIG. 2C is a schematic illustration of an exemplary design for the reactor core of the FIG. 2B reactor.

FIG. 3A is a schematic illustration of a thermal energy electrical power generation system (TEGS) in accordance with embodiments of the invention. FIG. 3B is a schematic illustration of a thermal energy heating system (TEHS) in accordance with embodiments of the invention. FIG. 3C to 3E are graphs that illustrate conversion efficiencies for various thermal to electrical power generation systems.

FIG. 4 is a schematic illustration of an example embodiment of an integrated system comprising a nuclear reactor, a TEGS, and a TEHS.

FIG. 5A depicts a colony installation on a planetary surface. FIG. 5B depicts a nuclear reactor of the type described herein buried in regolith of a planetary surface.

FIG. 6A is a schematic illustration of the FIG. 2B reactor fitting inside of a launching rocket. FIG. 6B is a schematic illustration of a superstructure containing a reactor core housed in a pressure vessel encapsulated as a stage in a launch rocket.

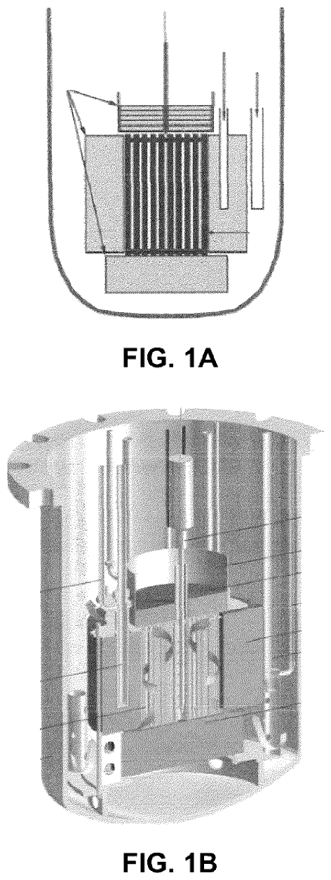

### DETAILED DESCRIPTION

Various apparatuses, methods and compositions are described below to provide an example of an embodiment of each claimed invention. No embodiment described below limits any claimed invention, and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, such as, for example, a continuing patent application. The applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it should be understood that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising,” and variations thereof mean “including but not limited to,” unless expressly specified otherwise. A listing of items does not imply that any or all of the items are mutually exclusive, unless expressly specified otherwise. The terms “a” “an” and “the” mean “one or more” unless expressly specified otherwise.

Embodiments described herein relate generally to the generation, storage, and transmission of thermal energy and electrical energy on a lunar or planetary environment.

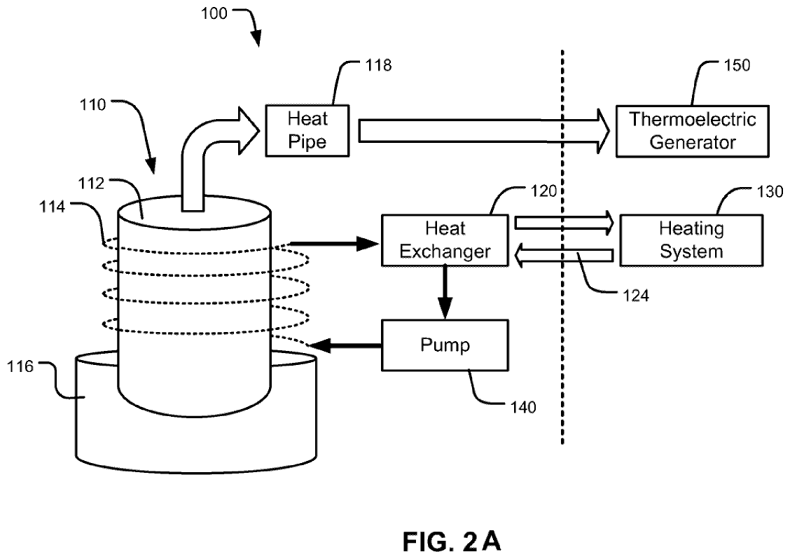

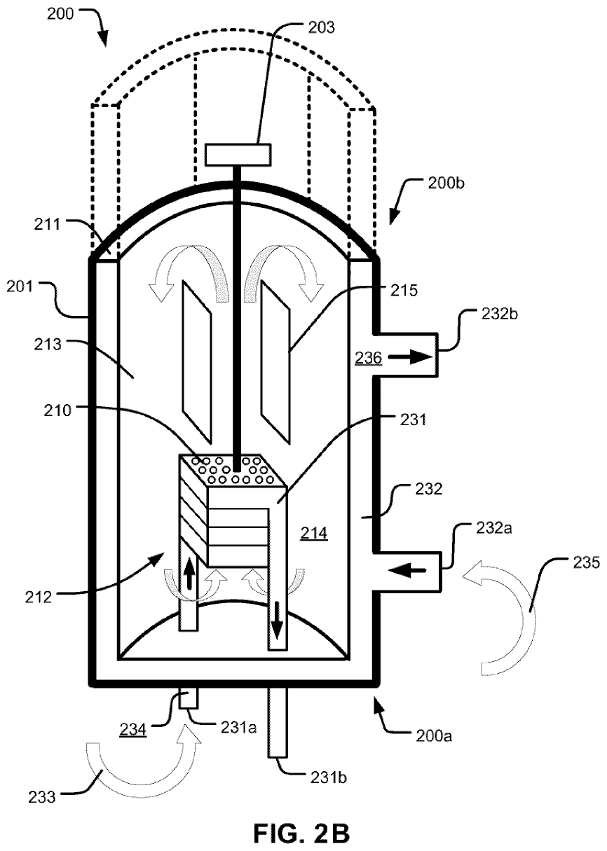

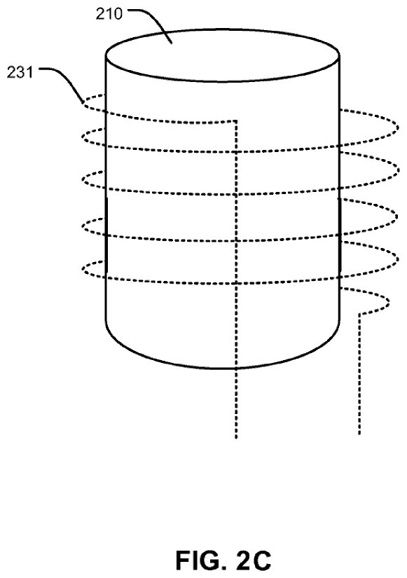

Referring now to FIG. 2A, shown therein is a block diagram of an integrated system 100 for providing power, electricity, and/or district heating. System 100 includes a nuclear reactor 110, a heat exchanger 120, and a heating system 130. Nuclear reactor 110 may be designed for operation at a level of reactivity that is below criticality. As such, nuclear reactor 110 may be referred to herein as a “subcritical reactor”, a “controlled reactor”, or a “controlled reactivity reactor”. Compared to traditional nuclear reactors that are designed to produce maximal amounts of power, reactor 110 may be designed or otherwise configured to output power in the range of 10 kW to 200 kW of power. Although such reactors output less power, they can offer several advantages over traditional critical reactors. For example, reactor 110 may be more environmentally friendly than critical reactors since they tend to produce less nuclear waste. As another example, reactor 110 may be operated at lower costs compared to existing nuclear reactors. Compared to critical nuclear reactors, reactor 110 is also less susceptible to risks like runaway nuclear reactions, thereby allowing reactor 110 to be provided in closer physical proximity to heating system 130 and the communities which rely on system 130 for power.

In the illustrated embodiment, a reactor core 112 of reactor 110 is cooled by one or more active cooling loops 114. Optionally, reactor core 112 may be immersed or partially submerged in a cooling bath 116. Cooling bath 116 may be provided in a tank, a container, or the like. Cooling bath 116 provides a passive means for cooling reactor core 112 to enhance the safety of subcritical reactor 110. Cooling bath 116 may be omitted when system 100 is used in extraterrestrial environments.

Active cooling loop 114 may be implemented by a thermal fluid pump system 140. In operation, thermal fluid pump system 140 circulates a fluid (e.g., water, glycol, ammonia, or other suitable thermal fluids) through active cooling loop 114 to draw heat away from reactor core 112. Heat exchanger 120 is thermally coupled to active cooling loop 114 to extract heat from the fluid heated by reactor core 112 and exiting reactor 110. For the purposes of facilitating the description, the term “thermally coupled” is used herein to refer to a coupling that allows heat exchange. Two components are considered to be “thermally coupled” if they are capable of exchanging heat with each other.

Heat exchanger 120 may be a shell and tube heat exchanger, a double pipe heat exchanger, a plate exchanger, a radiator, a heat pipe, or the like. As depicted in FIG. 2A, heat exchanger 120 extracts heat from the relatively hot fluid flowing away from reactor 110, thereby cooling the fluid. The relatively cool fluid is then recirculated by thermal fluid pump system 140 through active cooling loop 114 to draw more heat away from reactor 112. Heat exchanger 120 is coupled to heating system 130 which delivers the extracted heat to district heating systems, residential spaces, industrial spaces, etc.

Optionally, one or more heat pipes 118 may be provided in subcritical reactor 110 to draw heat directly away from reactor core 112. The heat pipes 118 may be filled with a phase change material or other fluids. The heat pipes 118 may be coupled to a thermoelectric generator 150 (e.g. Peltier engine, Stirling engine, or other thermodynamic engines) for providing electricity to communities, residential spaces, industrial spaces, etc. The electricity provided by generator 150 may be used, for example, to power active cooling systems as well as reactor systems.

Reactor 110 includes features which allow reactor 110 to provide energy to communities (e.g., through heat exchanger 120, heat pipes 118, etc.). As such, reactor 110 may also be referred to herein as an energy generating system. FIG. 2B is a schematic illustration of an energy generating system 200 according to an example embodiment. System 200 may be designed or otherwise configured for use on lunar or planetary environments. System 200 may be operated in an extraterrestrial environment to generate energy from nuclear reactions. As described in more detail below, system 200 may include means for both actively cooling and passively cooling its nuclear reactor core 210.

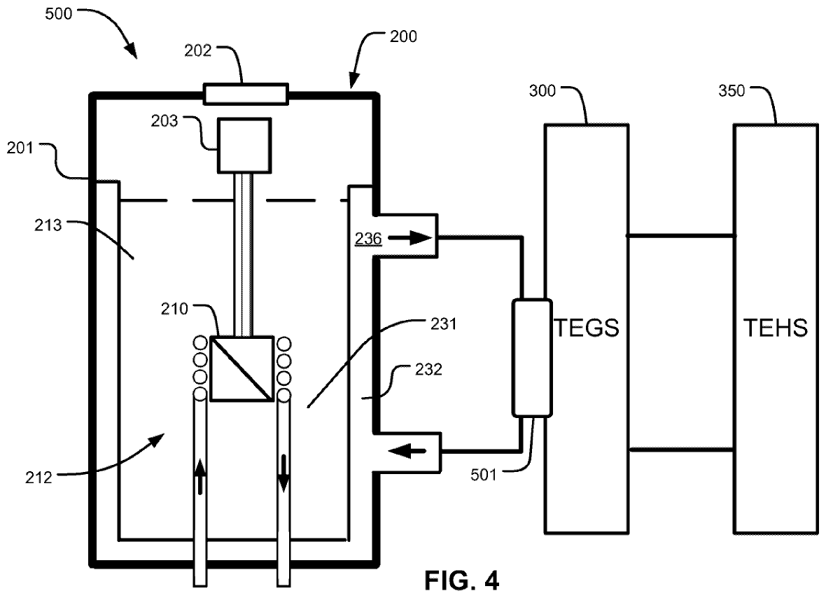

As depicted in FIG. 2B, reactor core 210 of system 200 is housed in a pressure vessel 211. Pressure vessel 211 may be disposed within a containment shield 201. Containment shield 201 may be tubular shaped. In one embodiment, containment shield 201 has the shape of a cylinder with a diameter of about 3 meters and a height of about 5 meters. Pressure vessel 211 has an access hatch 202 (e.g., see FIG. 4A) for enabling access to the interior of the pressure vessel 211 from outside the containment shield 201. Pressure vessel 211 may be made of steel, or other suitable materials, for burying in regolith.

Nuclear reactor core 210 is suspended within pressure vessel 211 and has its temperature regulated by a coolant system 212 as shown in FIG. 2B. Coolant system 212 may rely on water-based coolants where, for example, the reactor core 210 is cooled through a natural convection process provided by light water reservoir 213. Such process may be considered as an example of a passive means for cooling reactor core 210. Coolant system 212 may also support more active means for cooling reactor core 210. In the illustrated embodiment, coolant system 212 includes first and second heat exchangers 231, 232 which work together in operation to actively transfer heat (i.e., thermal energy) away from nuclear reactor core 210. First and second heat exchangers 231, 232 may comprise plate-type heat exchangers, or the like.

First heat exchanger 231 is thermally coupled to nuclear reactor core 210. First heat exchanger 231 may be in direct physical contact with nuclear reactor core 210 to transfer thermal energy directly away therefrom. First heat exchanger 231 may be coaxial with nuclear reactor core 210. First heat exchanger 231 may fully or partially surround nuclear reactor core 210. For example, first heat exchanger 231 may be shaped to wrap around a tubular shaped reactor core 210 as depicted in FIG. 2C. As another example, first heat exchanger 231 may be shaped to wrap around a reactor core 210 that is cubical in shape as depicted in FIG. 2B. Other core shapes and heat exchanger shapes are also envisaged in other designs to facilitate good thermal coupling between reactor core 210 and first heat exchanger 231.

A first fluid transport system 233 may be provided as part of system 200 for circulating a first fluid medium 234 (e.g., a liquid medium or a pressurized liquid medium) through the first heat exchanger 231. Through the thermal coupling between first heat exchanger 231 and nuclear reactor core 210, the circulated fluid 234 may be heated to a temperature of about 1000° C. in some embodiments. In other embodiments, the circulated fluid 234 may be heated to a temperature in the range of 750° C. to 1000° C. In such embodiments, the circulated fluid 234 may be a molted salt or other coolant fluids with high heat capacity. In other embodiments, the circulated fluid 234 may be heated to a temperature in the range of 100° C. to 300° C. In such embodiments, the circulated fluid 234 may be pressurized water.

Second heat exchanger 232 is thermally coupled to nuclear reactor core 210 through reservoir 213. Second heat exchanger 232 and first heat exchanger 231 can function together in operation to transfer heat away from the nuclear reactor core 210. Second heat exchanger 232 may be radially spaced from nuclear reactor core 210 as shown in FIG. 2B. Second heat exchanger 232 may be coaxial with first heat exchanger 231.

A second fluid transport system 235 may be provided as part of system 200 for circulating a second fluid medium 236 (e.g., a liquid medium, a pressurized liquid medium, light water, etc.) through the second heat exchanger 232. Through the thermal coupling between the nuclear reactor core 210, second heat exchanger 232 and reservoir 213, second fluid medium 236 is heated to a second temperature as it is circulated through the second heat exchanger 232 during operation of system 200. For example, second fluid medium 236 may be water or another fluid entering second heat exchanger 232 at a temperature of under 50° C., and exiting second heat exchanger 232 at a temperature of about 95° C. As another example, second fluid medium 236 may be a two phase coolant. In the illustrated embodiment, the second fluid medium 236 enters the second heat exchanger 232 at a proximal end 200a of the thermal energy generating system 200 and exits the second heat exchanger 232 at a distal end 200b of the thermal energy generating system 200.

Second fluid transport system 235 may include one or more pumps for regulating the flow of second fluid medium 236. For example, the pumps may be operated to maintain a constant flow of about 120 kg/s in the second heat exchanger 232. As another example, the pumps may be operated to maintain a fluid pressure of about 350 kPa(g) downstream the pumps. In general, the pumps may be operated to adjust the flow rate of the fluid medium depending on the desired power output of the reactor. As an example, the pumps may be operated to circulate second fluid medium 236 at a pressure that is lower than 2 atm. The pumps may be operated to circulate second fluid medium 236 at higher pressures in situations where a higher heat capacity is desired.

A reactivity control system 203 may be provided as part of system 200 for controllably positioning one or more control rods within reactor core 210. The control rods can help control the reactivity and/or thermal output of reactor core 210. Control system 203 may be housed within the pressure vessel 211 and containment shield 201 as depicted in FIG. 2B. Access to control system 203, core 210, first fluid transport system 233 and reservoir 213 may all be provided through access hatch 202 (e.g., see FIG. 4A). In addition, a neutron irradiation hatch may be provided to facilitate neutron spectroscopy of mineralogical samples.

As illustrated in FIG. 2B, pressure vessel 211 may surround parts of the first heat exchanger 231, parts of the second heat exchanger 232, and the reactor core 210. In operation, nuclear reactor coolants 234, 236 may be circulated to actively transfer heat away from reactor core 210 through the thermal coupling between first heat exchanger 231, second heat exchanger 232, and reactor core 210.

In the illustrated embodiment, first heat exchanger 231 comprises a first heat exchanger first port 231a and a first heat exchanger second port 231b. First port 231a and second port 231b may be connected to first fluid transport system 233 to place first heat exchanger 231 in fluid communication with first fluid transport system 233. In operation, first port 231a may act or otherwise function as an inlet for receiving a relatively cold first fluid medium 234 from first fluid transport system 233. In operation, second port 231b may act or otherwise function as an outlet for expelling a relatively hot first fluid medium 234 out of system 200. The expelled first fluid medium 234 (i.e., the heated fluid) may be delivered to other systems for use in ISRU processes, such as metallurgical and water extraction processes. As an example, the expelled first fluid medium 234 may be used as fuel for thermoelectric or thermodynamic engines to provide electrical power on the Moon or in remote locations like the Arctic. As discussed in more detail elsewhere herein, the heat of system 200 can be transferred through heat pipes to various other devices or systems, including Peltier effect devices, or thermodynamic engines.

In the illustrated embodiment, second heat exchanger 232 comprises a second heat exchanger first port 232a and a second heat exchanger second port 232b. First port 232a and second port 232b may be connected to second fluid transport system 235 to place second heat exchanger 232 in fluid communication with second fluid transport system 235. In operation, first port 232a may act or otherwise function as an inlet for receiving a relatively cold second fluid medium 236 from second fluid transport system 235. In operation, second port 232b may act or otherwise function as an outlet for expelling a relatively hot second fluid medium 236 out of system 200. First port 232a may be located at the proximal end 200a of system 200 and second port 232b may be located at the distal end 200b of system 200 as shown in FIG. 2B. First port 232a and second port 232b may be designed to support a convective flow of second fluid medium 236 within the second heat exchanger 232 between the two ports 232a, 232b.

Light water reservoir 213 may act as or otherwise provide a container for a pool of water 214. The pool water 214 may serve as a moderator, a heat transfer medium and shielding for reactor core 210. In some embodiments, reservoir 213 comprises a pool water purification system for maintaining pool water purity and pH within required limits. The purification system can be operated to remove dissolved materials to control the concentration of radioactivity from oxidation of stainless steel structures and from a potential fuel sheath defect. The purification system may comprise a pump, a cooler, a recuperator, two filters, an ion-exchange column and/or a chemical addition tank. Hydrogen accumulating in the cover gas, from the radiolytic decomposition of pool water, may be recombined passively using modular screens, coated with wet-proof catalyst. For extraterrestrial applications, the water may be produced through ISRU to reduce the cost required for providing system 200.

In some embodiments, primary heat transport away from reactor core 210 is achieved by natural circulation of the pool water 214 rising through the reactor module and the riser duct 215 into two in-pool heat exchangers (not shown) where the pool water 214 is cooled by a secondary circuit. In such embodiments, the primary flow from the heat exchangers descends to the inlet plenum where it re-enters the reactor module. Natural circulation can facilitate core cooling without the need to depend on the reliability of pumps or the integrity of electrical supply for the pump motors. Natural convection, which is driven by gravity, may be reduced to negligible levels under lower gravity conditions.

The power level of reactor 200 is regulated by control system 203 to, for example, keep the water leaving the second heat exchanger 232 at a fixed temperature of about 75° C. In some embodiments, the full power level of reactor 200 is regulated (e.g., at 20 KW to 50 KW) to maintain the temperature of the water rising from reactor core 210 at about 95° C. and the flow at about 120 kg/s. In some embodiments, control system 203 is configured to automatically reduce the reactor power if the core outlet temperature exceeds about 95° C. or if the temperature rise across the core is greater than about 20° C. In such embodiments, the temperature of the water (e.g., stagnant water in terrestrial applications) above the heat exchangers may span between about 75° C. and 95° C., depending on the power level. In other embodiments, the temperature of the water may be higher than 95° C. (e.g., in embodiments with higher pressure in the active cooling loops).

To compensate for fuel burnup, absorber plates may be used for periodic core reactivity adjustments by a remote operator. The absorber plates may be made of lead or other dense metal (e.g., depleted uranium). In addition, absorbers under computer control may be used for load following. The rate of removal of all absorbers is limited by the speeds of their electric motors and by a timer requiring manual reset. The use of a fully redundant control system reduces the probability of unwanted shutdowns.

In the event of loss of secondary flow such as a power interruption to the pumps of fluid transport systems 233, 234, the large pool volume provided by reservoir 213 delays core temperature rise. As a result, thermal transients can extend over many hours. This factor, combined with features that limit reactivity change rates to low values, eliminates the need to operate system 200 with fast acting shutdown systems that are essential for traditional pressurized power reactors. Illustratively, systems of the type described herein may provide up to 50 KW of thermal energy in water at less than 95° C.

Reactor core 210 may be fueled by, for example, highly enriched uranium (HEU), low enriched uranium (LEU), high assay low enriched uranium (HALEU), or other compositions of the like. Table 1 below provides a comparison between HEU and LEU fueled reactor cores. System 200 can benefit from using natural fuels that are available on the moon (e.g., uranium, thorium, or other types of fuel used in CANDU reactors). This can help make system 200 compatible with other ISRU processes. When LEU is used, the space flight in the launch rocket may carry a fueled core. If the natural fuel extracted from the lunar surface is used, then an unfueled core may be transported from Earth to space or buried on the Moon.

TABLE 1

[symbol]

| | |
|---|---|
| HEU-f [symbol] ed | LEU-f [symbol] ed |

| | | | | |
|---|---|---|---|---|
| core [symbol] | 220 | mm | 220 | mm |
| core height | 228 | mm | 234 | mm |

| | | |
|---|---|---|
| number of fuel pins | 296 | 198 |

| | | | | |
|---|---|---|---|---|
| fuel pin diameter, with cladding | 5.23 | mm | 5.26 | mm |
| fuel length | 225 | mm | 234 | mm |

| | | |
|---|---|---|
| Cladding | Aluminum | Zircaloy-4 |
| Fuel | [symbol] 28% alloy | LiO [symbol] |

| | | | | |
|---|---|---|---|---|
| total mass of uranium | 0.9 | kg | 5.6 | kg |

| | | |
|---|---|---|
| enrichment U-235 | 93% | 19.89% |

| | | | | |
|---|---|---|---|---|
| total mass of U-235 | 0.82 | kg | 1.12 | kg |
| volume of water [symbol] | 7.8 | L | 8.1 | L |

[symbol]

indicates data missing or illegible when filed

System 200 may be operated with one or more secondary systems, including systems which generate electrical power from thermal energy (TEGS) and thermal energy heating systems (TEHS). TEHS may include heating system 130 shown in FIG. 2A, as well as other heating systems. TEGS may include thermoelectric generator 150 shown in FIG. 2A, as well as other generators. System 200 may also be operated with a solar power system or a solar power concentrator to, for example, help raise the operational temperature of the coolant.

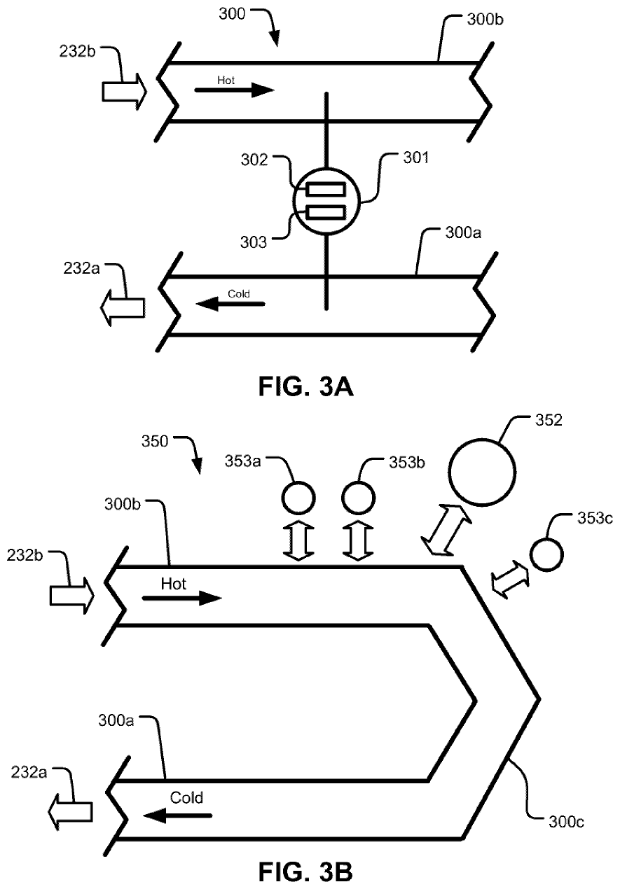

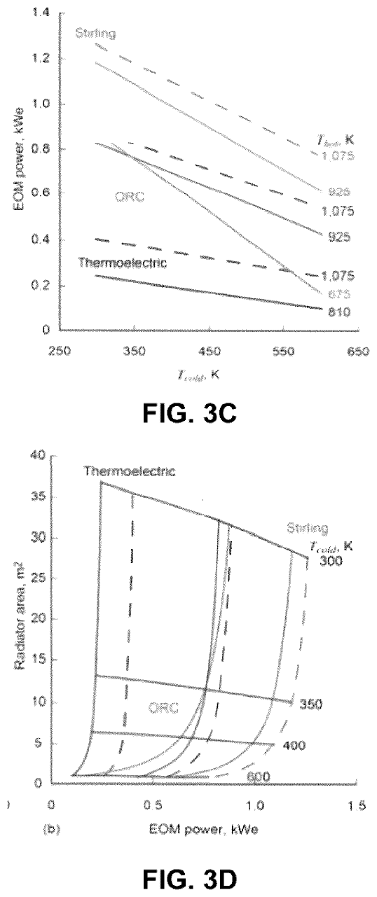

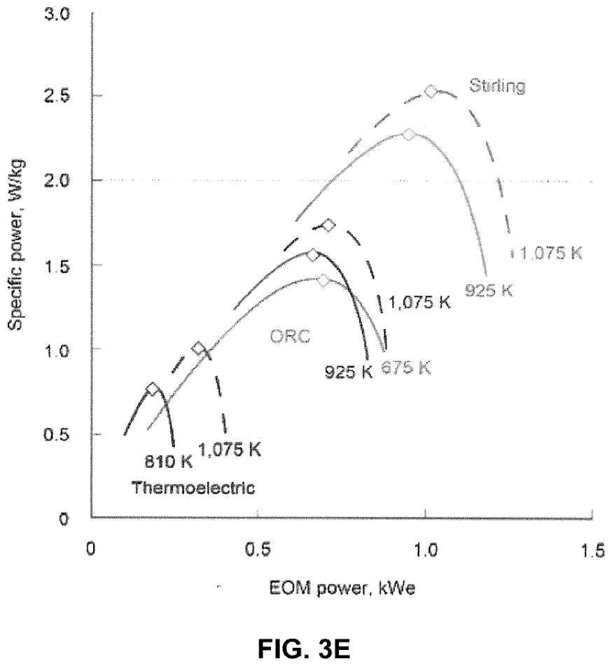

Referring now to FIG. 3A, shown therein is a schematic of a TEGS 300 according to an example embodiment. TEGS 300 comprises heat pipes 300a, 300b that can be coupled to the fluid transport system(s) of system 200 to facilitate thermal energy transfer between system 200 and TEGS 300. In the illustrated embodiment, TEGS 300 comprises a cold heat pipe 300a for transferring heat from a first port 232a of second heat exchanger 232, and a hot heat pipe 300b for transferring heat from a second port 232b of second heat exchanger 232. Disposed between cold heat pipe 300a and hot heat pipe 300b is a thermoelectric energy generator 301. Thermoelectric energy generator 301 relies on a difference in temperature between the hot heat pipe 300b and the cold heat pipe 300a to generate electrical energy. TEGS 300 may also comprise a cold heat pipe for transferring heat from a first port 231a of first heat exchanger 231, and a hot heat pipe for transferring heat from a second port 231b of first heat exchanger 231.

Thermal electrical energy generator 301 may generate a DC voltage, an AC voltage, or a combination of the two as needed with one or more AC/DC inverters, DC/AC inverters, and DC/DC converters. Thermal electrical energy generator 301 may include one or more of the following thermal to electrical energy generating systems: a thermoelectric generator (TEG) or a Seebeck generator 302 (i.e., a solid state device that converts heat flux or temperature differences directly into electrical energy through a phenomenon called the Seebeck effect or another thermoelectric effect), a Stirling engine 303, and other generators of the like. Stirling engine 303 may include a sealed cylinder with one part hot and the other cold. In operation, a working gas (e.g., air, helium, or hydrogen) inside engine 303 is moved from the hot side to the cold side, creating mechanical motion which can then be converted to electrical energy.

FIGS. 3C, 3D and 3E illustrate conversion efficiencies for various example embodiments of electrical energy generator 301, including TEGs, generators based on Organic Rankine Cycle (ORC) technology, and Stirling engines.

Referring now to FIG. 3B, shown therein is a schematic of a TEHS 350 which may be used for district heating. TEHS 350 comprises means for coupling hot heat pipe 300b and/or cold heat pipe 300a to other systems. As an example, hot heat pipe 300b may be thermally coupled to a thermal dump backup system 352 as well as various equipment heat exchangers 353a, 353b, 353c. TEHS 350 may also include a return section 300c for hot heat pipe 300b to return fluid to cold heat pipe 300a. Further downstream, cold heat pipe 300a may be in fluid communication with second heat exchanger first port 232a (as shown) and/or first heat exchanger first port 231a (not shown) to circulate the cooler liquid medium through system 200. In extraterrestrial applications, heat pipes 300a, 300b may be used to cool and provide heat energy to the volatiles and consumables production on the Moon.

Referring now to FIG. 4, shown therein is a schematic of a comprehensive system 500 which integrates nuclear reactor 200, TEGS 300, and TEHS 350. In the illustrated embodiment, a secondary heat exchanger 501 thermally couples TEGS 300 with the second liquid transport system 234 of nuclear reactor 200. TEHS 350 is also connected to second liquid transport system 234 to provide a district heating unit.

Additional aspects of the invention are described below with reference to the following example applications, which are intended to be illustrative and not limiting in scope.

### Extraterrestrial Applications

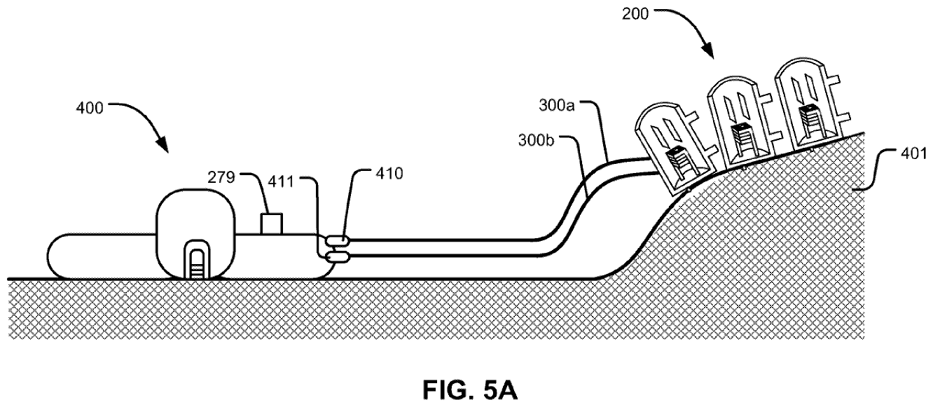

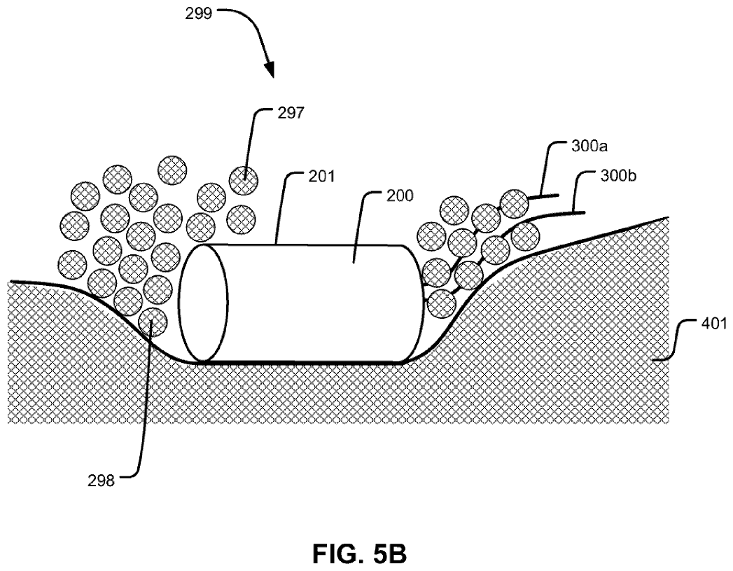

FIG. 5A depicts a colony 400 on the lunar or planetary surface. The colony 400 may be located proximate to a crater 401, where a wall of the crater (not shown) may isolate colony 400 from one or more nuclear reactors 200. The nuclear reactors 200 may be coupled together in a redundancy array. Colony 400 may include an electrical coupling 410 and a thermal coupling 411 with system(s) 200 (e.g., through heat pipes 300a and 300b). Through thermal coupling 411, heat generated by system(s) 200 may be used for district heating of colony 400. Through electrical coupling 411, electrical power may be provided to colony 400. Colony 400 may include one or more energy storage devices 279. Energy storage device(s) may be coupled with the electrical coupling 410 for storing of electrical energy generated by the system(s) 200 and for delivering electrical power throughout colony 400.

For district heating purposes, a standard room temperature is about 20° C. District heating system is envisaged using hot water, with supply temperatures in the range of 90° C. to 160° C., and steam with pressures typically in the range 400 to 3000 kPa. There may also be considerable advantages in operating system(s) 200 to produce hot water at temperatures of less than 100° C. at the second heat exchanger 232, thereby potentially eliminating the need for pressurized systems.

In some cases, a plurality of systems 200 may be linked into reliability enhancing two-packs, four-packs and six-packs, where the reliability enhancing packs may be stacked together in the same launching rocket 290 or coupled together in-situ. Power generated from the packs of systems 200 may be stored in energy storage device 279 (e.g., see FIG. 5A). Energy storage device 279 may include various mechanical and electrostatic storage devices, such as metallic oxidizing storage devices, flywheels, and supercapacitors. Alternatively or in addition, a cascade of neutrons can be formed within system 200.

In some cases, the mass of the reactor installations into the lunar soil are constructed with in-situ resources.

Factors in selecting a location for a reactor on the lunar or planetary surface include, but are not limited to distance capabilities of the Lunar Terrain Vehicle (LTV), slope and roughness of the surface, distance from landing pads, and distance from locations of research (such as permanently shadowed regions). A concept study may reveal the optimal location for a reactor depending on Artemis Base Camp site selection as well as the plethora of safety, travel, and convenience factors. A mobile reactor can be used to perform high fluency neutron spectroscopy protection of the terrain it crosses. Furthermore, heat generated by the reactor can be used to sublimate water or ice found in the lunar poles or regolith.

A protective structure may be provided in some cases to cover systems 200 that are provided on the lunar surface and/or covered in regolith. These protective structures may require construction capabilities, regolith processing, and additive manufacturing techniques. Various methods and systems are contemplated to shield systems 200 most efficiently and effectively on the lunar surface.

Multiple systems 200 may be transported from the Earth to outer space in packs. However upon arrival on the lunar surface it may be advantageous to physically separate systems 200 for higher reliability. Accordingly, an overhead cover may be provided in some cases to improve durability during micrometeorite impacts and heavy particles solar storms.

System 200 may be operated to generate electrical energy from a water-cooling loop with a turbine or a high efficiency thermodynamic Stirling Cycle engine. Other technologies such as Peltier junctions are also envisaged.

Referring to Table 2 below, shown therein are various colony or base camp activities that use power as well as their power consumption estimates. There are various activities that are required to maintain a lunar base camp, and most of them require power for operation.

TABLE 2

| | Maximum | | | |
|---|---|---|---|---|
| | Estimated | Thermal | Electric | |
| U [symbol] | Demand (kw) | Needs | Needs | Considerations/Comments |
| Mining/ISRU [1] | 100-1000 | High | High | Includes water exp [symbol] , oxygen production, and |
| | | | | other ISRU activities. Estimate is dependent on |
| | | | | number of avctivities. |
| Habitat [1] | 100 | High | High | Assumes 6-person base camo. |
| Agriculture [2] | 100 | High | High | Assumes lunar gardens require similar conditions to |
| | | | | the astro [symbol] habitats. |
| Charging covers/ | 55 | Low | High | Estimate is dependent on number and type of covers, |
| Equipment [1] | | | | Includes power required for a charging station. |
| Radiation | 10 | Low | Medium | Shielding from electrostatic/electric field. Estimate is |
| Shielding [1] | | | | dependent on level of required shielding. |
| Communications | 1 | Low | Low | Estimate of a single transmitter. |
| System [1] | | | | |

[symbol]

indicates data missing or illegible when filed

System 200 may be a 50 KW thermal energy system. Multiple systems 200 may be arranged in a packed configuration to meet the requirements of the colony or base camp activities.

FIG. 5B illustrates a system 200 that is at least partially buried in the regolith 298 of an interplanetary or lunar surface 299. With the passive cooling approach, a typical SLOWPOKE reactor would normally require a 10 meter hole to be dug into the regolith, with about 5 meters being left open at the top soil level. With the active cooling approach, the reactor may be buried a few meters beneath regolith 298. Regolith 298 is quite compacted after about 2 meters in depth and can therefore be difficult to penetrate for burying a conventional SLOWPOKE reactor, which is typically vertically disposed with a central axis that is parallel to gravity. Regolith 298 may provide or otherwise act as a cold sink to enhance the Carnot efficiency of the reaction processes. When used in lunar pole conditions, system 200 may be able to produce water from the ice contained in regolith 298 and permafrost conditions herein.

Where a hole or crater is created, the superstructure 201 or containment may be horizontally oriented (i.e., a cylindrical superstructure is disposed with the radius parallel with the direction of gravity) and disposed within the hole. Thereafter, regolith 297 may be piled up around the superstructure 201 as required for cosmic radiation confinement. In some cases, system 200 may be disposed in the regolith such that replacement of reactor core rods and their maintenance can be facilitated.

Illustratively, about 80% of all power generated in system 200 is in the form of heat. Thus, system 200 can provide heat to colony 400 while about 20% of the thermal power generated is converted into electrical energy by electrical generator system 300.

The lunar station or colony 400 may be located near a PSR pole source of water ice and/or be collocated with key ISRU ore deposit mines. The mines will have high autonomy and will need resilient sources of base energy, as the reactors will need not to freeze during a power mishap or during the long lunar night.

In some applications, the generation, storage, and transmission of power may be provided through a microgrid of multiple electrical couplings 410. Microgrids can work independently of a main plant (i.e., systems 200), providing power even when another aspect of the transmission system breaks down. However, microgrids turn unstable and can potentially collapse when a significant portion of the produced power is intermittent. A strong energy base is generally desirable to prevent malfunction.

System 200 can provide a reliable source of continuous energy and is therefore a suitable option to power a microgrid. In some cases, an array of systems 200 is preferable when one is being serviced. As described above, system 200 can use Low Enriched Uranium and can likely accommodate natural Uranium and Thorium. These fuels are widely found in KREEP (e.g., potassium, rare-earth elements and phosphorus), which is a geochemical component of some lunar impact breccia and basaltic rocks. Material deposits are available on the lunar surface, and it is expected that refueling can be carried out locally with in-situ resources.

Having adequate power being supplied by multiple systems 200 can facilitate the In-Situ Resources needs for heat to process regolith (e.g., between 900° C. to 1800° C.). A heat transfer loop using melted salts (widely used in Solar concentration on Earth) or heat pipes can be used to cool and provide heat energy to the volatiles and consumables production on the Moon. Storage of consumables and volatile into liquid phase can be highly energy intensive, even considering the Permanently Shadowed Region (PSR) low temperatures found in deep lunar craters. Systems 200 can facilitate this need.

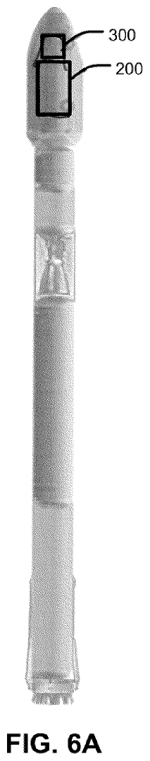

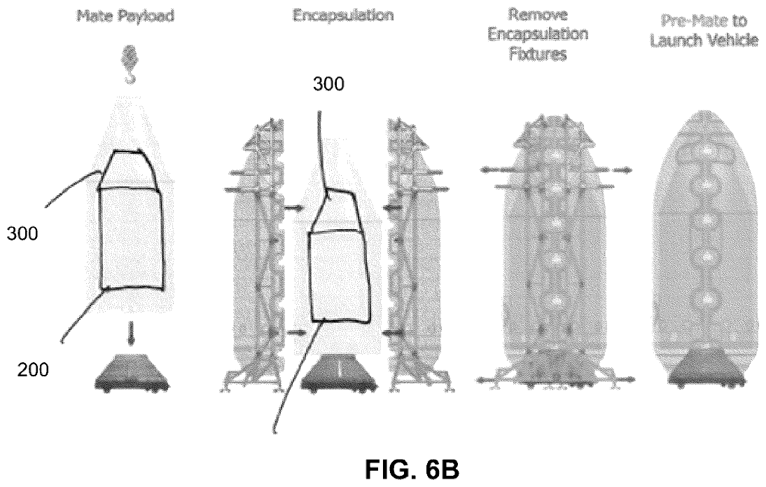

FIG. 6A depicts system 200 and TEGS 300 fitting inside a launching rocket 290 for deploying system 200 and TEGS 300 into space. System 200 and TEGS 300 may be deployed into the lunar or interplanetary orbit and space as separate components or as an assembly. In some cases, the size of system 200 is small enough to fit within the current generation of space launchers, such as the Falcon 9 rocket. The superstructure 201 may form at least partial sidewalls of a stage of the launching rocket 290.

For example, the launching rocket, may be a two-stage launch vehicle powered by liquid oxygen (LOX) and rocket-grade kerosene (RP-1). The launching rocket or launch vehicle may be one that is designed, built and operated by SpaceX™. The Falcon 9 can be flown with a fairing. The diameter of the fairing may be about 3.66 meters (12 ft) and 5.2 meters (17 ft) in height. One or more systems 200 may be fitted as part of the fairing. In some cases, multiple systems 200 and/or TEGS 300 may be encapsulated together into the fairing of the falcon rocket (e.g., see FIG. 6B).

Where the superstructure 201 forms sidewalls of the payload of the launch rocket (e.g., see FIG. 6A), the superstructure 201 of system 200 remains upon removal of the fairing and is then deployed and erected onto the lunar or planetary surface.

System 200 may be launched without water as water may cause sloshing in the launch process. Therefore it may be preferable to launch pressurized oxygen and pressurized hydrogen in tanks such that upon requiring of filling water into the reactor core, the hydrogen and oxygen may be reacted together on the lunar or interplanetary surface to generate thermal energy or electrical energy or a combination of both, which may be used to power other equipment (e.g., Space-Based Robotics systems). Water available in the cis-lunar space may also provide for the cooling water. Obtaining the water from the cis-lunar space may be preferable because of the high costs associated with sending it from earth may be too costly for sustained operations.

System 200 may be optimized based on launch vehicle size, weight, volume, acoustic vibrations and morphology for launch and landing flight segments will be devised. The top end superstructure, heat exchangers, cooling water, core (bottom-end) may be flown separately and assembled on the lunar or planetary surface.

Initially the first complete system 200 would be sent to the lunar surface and thereafter mining and processing of materials derived of the lunar surface would facilitate creation of additional components of additional systems 200 and thus reducing a need for these components to be sent from earth.

The presence of lunar resources (e.g., regolith, natural thorium and uranium sources, concrete and cooling water are a few examples) can optimized to minimize launch and operations cost using the Mass Payback Ratio methodology.

Systems described herein may include means for facilitating transport to various locations. For example, the systems may include means for mounting to a mobile system such as a lander or a rover. This would enable the systems to be moved on demand to service different areas on the Moon, or another planetary body. The mobility provides the systems with more flexibility for use in habitats, industrial activities, science, mining, and other evolving markets.

### Terrestrial Applications

Systems described herein can be modified for use in various terrestrial applications. For example, system 200 can be coupled to an external heating or cooling loop to power buildings, communities, faculties, installations, etc. The modified systems can be used in a wide variety of environments, including but not limited to marine environments, submarine environments, arctic environments, or any other on grid or off grid environments (e.g., beach, wilderness, refugee camps, etc.). In remote areas, the modified systems can be adapted for use as a thermal generator to displace the use of diesel generation as a baseload energy. In some cases, the modified systems can also be used to generate electricity.

The modified systems may include one or more of the following: solar photovoltaics, concentrators or other energy co-generation technologies, cooling baths, supplementary or secondary safety systems, etc. The modified systems may be stationary within a building, mobile, or portable. For example, the modified systems can be mobilized on a rover, truck or barge for relocation on demand to suit the needs of various energy requirements around various different locations. Additional exemplary terrestrial applications are described in more detail below.

### Irradiation of Food

The modified systems can be used to help prevent food from spoiling. This can be accomplished by generating a neutron flux using, for example, system 200 and irradiating the bacteria inside food with the neutron flux. The food can be placed in a specially designed room beside system 200 with a window or opening that exposes the food to the neutron flux. The neutron flux can deactivate or otherwise remove bacteria from food, but not viruses in some cases. Bacteria typically spoils food like meat and can cause food borne illnesses and other hazards.

Illustratively, using system 200 in such a manner can help solve the problem of food security, especially in an extraterrestrial environment or in remote areas like the arctic which have experienced extreme temperature swings due to climate change.

### Mining Applications

The modified systems can be used to process minerals, oils, oil sands, and the like, with a minimal carbon footprint. In particular, the systems can be used in early stage mines which don't have a large infrastructure. As an example, the systems can be used to initiate various materials processes and metallurgy to increase the temperature and offset the need for a significant amount of external thermal energy. As another example, the neutron flux generated by the systems can be used to image minerals.

One or more heat pipes may be used in conjunction with the modified systems to open up new opportunities for metallurgy and materials processing. Heat pipes can carry more heat than copper (e.g., 400 times more) and can raise the temperature of system 200 to as high as just below 1000° C., thereby allowing the system to melt materials like aluminium. Heat pipes can also be used with phase change materials or gases that undergo a phase change during heat transfer between two solid materials. The heat pipes can be used to extra heat from the modified systems or to raise the temperature of the water in the systems.

### Water Purification

Systems described herein can be used in association with water purification systems (e.g., reverse osmosis systems) or desalination systems to serve remote communities, militaries, wilderness, industrial, disaster relief, refugees, or inhabitants on an extraterrestrial body.

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Unless the context clearly requires otherwise, throughout the description and the claims: “comprise,” “comprising,” and the like are to be construed in an inclusive sense, as opposed to an exclusive or exhaustive sense. “Herein,” “above,” “below,” and words of similar import, when used to describe this specification shall refer to this specification as a whole and not to any particular portions of this specification. “Or” in reference to a list of two or more items, covers all of the following interpretations of the word: any of the items in the list, all of the items in the list, and any combination of the items in the list. The singular forms “a,” “an,” and “the” also include the meaning of any appropriate plural forms.

Where a component is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Although the present invention has been described and illustrated with respect to preferred embodiments and preferred uses thereof, it is not to be so limited since modifications and changes can be made therein which are within the full, intended scope of the invention as understood by those skilled in the art.

1. A system for providing heating and electricity to a community, the system comprising:
a subcritical reactor comprising a reactor core thermally coupled to one or more heat pipes and an active cooling loop, the active cooling loop configured to facilitate circulation of a fluid therethrough;
a heat exchanger thermally coupled to the active cooling loop, the heat exchanger configured to extract heat from the fluid circulating through the active cooling loop;
a heating system for delivering the heat extracted by the heat exchanger to the community; and
a thermoelectric generator for converting heat extracted by the one or more heat pipes to electricity for delivery to the community.

2. The system of claim 1, comprising a thermal fluid pump system for circulating the fluid through the active cooling loop.

3. The system of claim 1, wherein the thermoelectric generator comprises one or more of a Peltier engine, a Stirling engine, and a Brayton engine.

4. The system of claim 1, wherein the subcritical reactor has a maximum power output in the range of 10 kW to 50 kW.

5. The system of claim 1, wherein the active cooling loop is in direct physical contact with the reactor core.

6. The system of claim 1, wherein the system comprises a tank for providing a cooling bath, and wherein the reactor core is immersed in the cooling bath during operation of the system.

7. The system of claim 6, wherein the active cooling loop is thermally coupled to the reactor core through the cooling bath provided by the tank.

8. The system of claim 7, wherein the one or more heat pipes are in direct physical contact with the reactor core.

9. The system of claim 1, wherein the community is an extraterrestrial community.

10. A thermal energy generating system comprising:
a nuclear reactor core housed in a pressure vessel and disposed within a containment and shield, the nuclear reactor core surrounded by a first heat exchanger and a second heat exchanger;
a first liquid transport system for circulating a first liquid medium through the first heat exchanger to within a first temperature range; and
a second liquid transport system for circulating a second liquid medium through the second heat exchanger to within a second temperature range; and
a thermal electrical generator system thermally coupled with the second liquid transport system,
wherein the second temperature range is lower than the first temperature range.

11. The thermal energy generating system of claim 10, wherein the first heat exchanger is coaxial with the nuclear reactor core.

12. The thermal energy generating system of claim 11, wherein the first heat exchanger is in direct contact with the nuclear reactor core.

13. The thermal energy generating system of claim 11, wherein the second heat exchanger is coaxial with the first heat exchanger.

14. The thermal energy generating system of claim 10, wherein the second heat exchanger is radially spaced from the nuclear reactor core.

15. The thermal energy generating system of claim 10, comprising a reactivity control system for controllably positioning control rods within the nuclear reactor core to control the reactivity and thermal output of the system.

16. The thermal energy generating system of claim 10, comprising a hatch for providing access to the nuclear reactor core, the first liquid transport system, and the second fluid transport system.

17. The thermal energy generating system according to claim 10, wherein the first liquid medium comprises molted salts.

18. The thermal energy generating system according to claim 10, wherein the second liquid medium comprises water.

19. The thermal energy generating system according to claim 10, wherein the thermal electrical generator system comprises a hot heat pipe, a cold heat pipe, and at least one of a Stirling generator, a Peltier generator, and a Seebeck generator located between the hot heat pipe and the cold heat pipe.

20. The thermal energy generating system according to claim 19, wherein a temperature difference between the hot heat pipe and the cold heat pipe is about 100° C. during operation of the system.

21. A method for providing a thermal energy generating system on a planetary body, the method comprising:
assembling a thermal energy generating system within a fairing of a launch vehicle as part of a stage;
launching the launch vehicle beyond Earth's orbit;
deploying the stage in space at a location where the stage is gravitationally attracted to the planetary body; and
landing of the thermal energy generating system on the planetary body;
burying at least a part of the thermal energy generating system within regolith; and
filling a reactor of the thermal energy generating system with water generated from a fuel cell interaction of pressurized hydrogen and oxygen.

22. (canceled)

23. (canceled)
